(19) United States
(12) Patent Application Publication
(10) Pub. No.: US 2026/0197573 A1
(43) Pub. Date: Jul. 9, 2026

(54) SUPPORT SYSTEM FOR SOUND CONVERTERS

(71) Applicant: Holoplot GmbH, Berlin (DE)

(72) Inventors: Michael BAROCCA, Körteste 6 (DE); Jaques SPILLMANN, Los Angeles, CA (US)

(73) Assignee: Holoplot GmbH, Berlin (DE)

(21) Appl. No.: 18/863,915

(22) PCT Filed: May 9, 2023
(86) PCT No.: PCT/EP2023/062227

§ 371 Date: Nov. 7, 2024

(30) Foreign Application Priority Data
May 9, 2022 (DE) 10 2022 111 521.6

(51) Int. Cl. H04R 1/02; G10K 11/00; H04R 1/40

(52) U.S. Cl. CPC H04R 1/026; G10K 11/004; H04R 1/403; H04R 2201/025; H04R 2201/401

(57) ABSTRACT

The invention relates to a support system having connection elements (201) for screwing on the left-hand side and connection elements (202) for screwing on the right-hand side of sound converter modules, characterized in that the connection elements each comprise two outer panels (203) between which an adjusting device, in particular for horizontal displaceability, implements a releasable connection of the modules to the elements (301) to (500), wherein this support system is suitable for connecting a large number of loudspeaker modules to a flat baffle.

The invention relates to a support system for sound converters, in particular for the construction of sound converter surfaces. It can be used as a standing or suspended system, especially for the construction of flat two-dimensional sound converter arrangements from loudspeaker modules.

Such modular arrangements are usually controlled according to the principle of wave field synthesis and can generate one or more sound wave fronts that can be controlled independently in the azimuth and elevation planes and the direction and opening angle of which can be adjusted separately. The loudspeaker modules do not need to be mechanically aligned, as is the case with line arrays. The control is achieved via discretely controlled levels and delay times of a large number of converters.

A support system is described with which a flat sound converter surface can be constructed from individual modules. This structure places special demands on a fastening system. On the one hand, the converter surface must not be interrupted by larger regions in which no converters contribute to the generation of the wave front. A distance between the modules that is too large would result in diffraction effects, which would result in unwanted side lobes outside the programmed directivity of the system.

The maximum size of the sound-emitting surface is limited vertically only by the mechanical load-bearing capacity of the material used; in the horizontal plane, the system can be extended as desired. As the size increases, special demands are placed on the precision of the positioning of the individual modules because the errors add up with the number of modules. However, in order to calculate the signal propagation time to each individual converter, the exact position of each individual converter is essential. Even a difference of just a few millimeters between the calculated position and the actual acoustic center of the individual converters results in location-dependent changes in the frequency response.

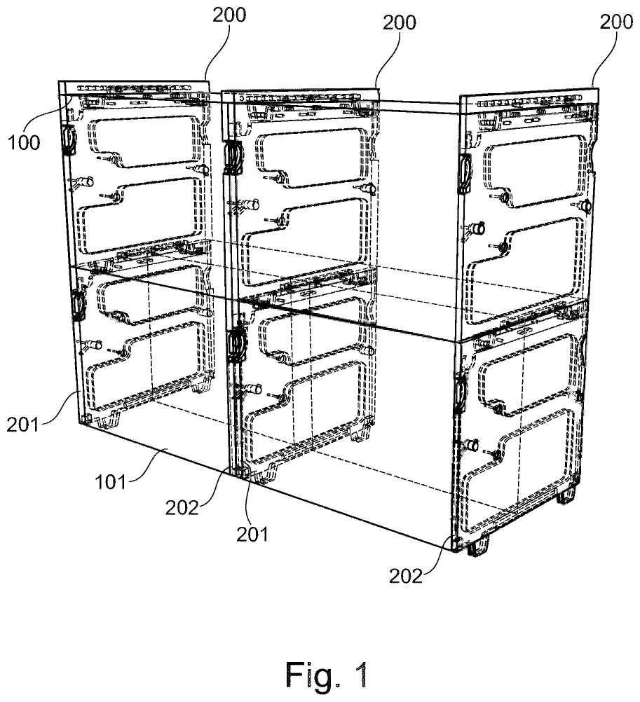

The object of the invention is therefore to provide a stable support system for sound converter modules, with which a large two-dimensional sound converter surface can be constructed without the tolerances that add up with the size of the system leading to errors in the reproduction range. The system can also be used for beamforming applications that are constructed as a two-dimensional radiator surface. In the following, the structure is described using the sketches in FIG. 1 to FIG. 4 as an example.

FIG. 1 shows the structure of a two-dimensional sound converter surface consisting of two modules 100 and two modules 101. In the following, starting from a view of the front side, a left and a right side are described.

The front dimensions of modules 100 and 101 are identical. In practice, however, not every module in wave field synthesis is equipped with a sub-bass loudspeaker. In the example, only module 100 has an additional converter for the bass range. It is therefore deeper than module 101. The support system has lateral elements (201) which are here constructed in a mirror image (i.e. differently). This serves for screwing on the left side and (202) for screwing on the right side of the individual modules and has two panels (203) between which an adjusting device (namely a variable mechanism) made up of the elements (301) to (500) realizes the detachable connection of the modules. The adjusting device can be used in particular to move the modules in or against the viewing direction (namely and back),

The mounting system is designed so that both module types 100 and 101 can be mounted at any position within the overall structure. It is also possible to install the type 100 modules in reverse, i.e. with their radiating side facing backwards. This design can be advantageous for individual modules in very large systems in order to achieve a cardioid directivity of the entire system, even in the bass range. However, the support system can also be manufactured with a smaller installation depth if only type 101 modules are used.

The system can be suspended from the trusses 200. However, a standing structure is also possible. For this purpose, standing feet are hung on the connecting bolts 403 on the floor, which distribute the load evenly. If they are designed to be height adjustable, precise alignment of the system can be ensured. High, standing systems can be secured against tipping to the trusses 200. The trusses 200 have a plurality of holes for fastening, so that the system can always be suspended at the center of gravity depending on the equipment with more or less deep modules.

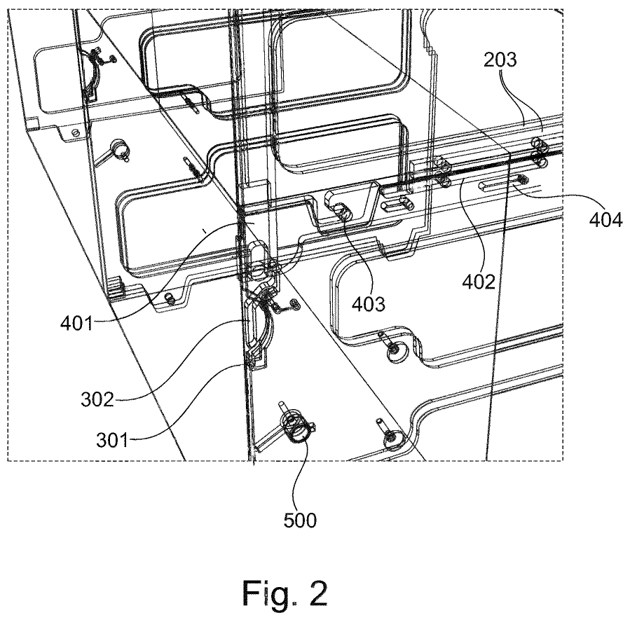

FIG. 2 shows a connection mechanism as it is screwed to the right side of each module. The left fastenings are each constructed in a mirror image. The vertical connection of the modules to a column is achieved via the movable latch 401 as part of the adjusting device. It is embedded between two outer panels (203) and can be moved along two guide pins. In the closed state, it hooks into the connecting bolts 403 connected to the module above. Then the sliding lever 302 is in the closed position, as shown in the sketch. The relative position of the systems connected as a column is then fixed against each other in all directions. A force-absorbing rail 402 can be provided for larger systems if there is a risk that the guide bolts 405 cannot absorb the vertical forces when erecting high module columns. An optional horizontal connection of the module columns using the connection elements 500 can improve the dimensional stability of the system. It is shown here in the closed state, where a pin would hook into the adjacent right module. However, other possibilities for horizontally connecting the panels using clamps, screws or hooks are also conceivable.

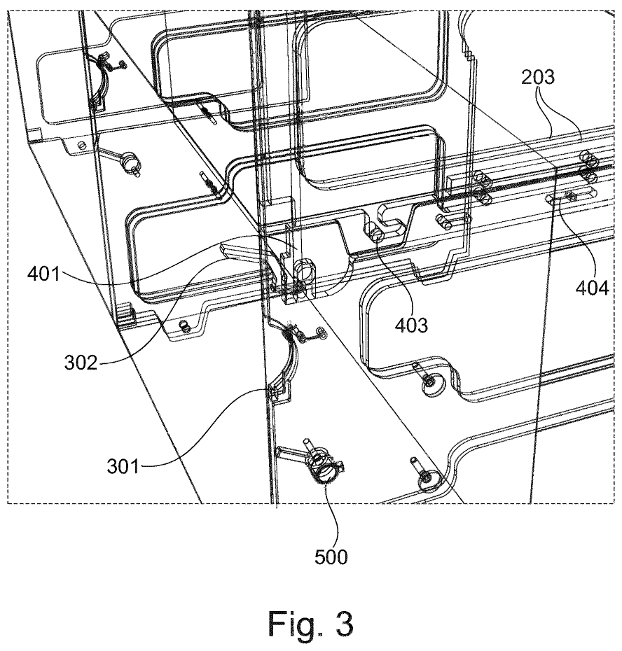

FIG. 3 shows the open position of the connection elements. The fixing lever 301 is pressed from the front to open the vertical connection. This allows the sliding lever 302 to be raised, causing the movable latch 401 to move into a position in which the upper module can be lifted with its connecting bolt 403. In its upper position, the horizontal connection element (500) releases the horizontal connection to the neighboring module.

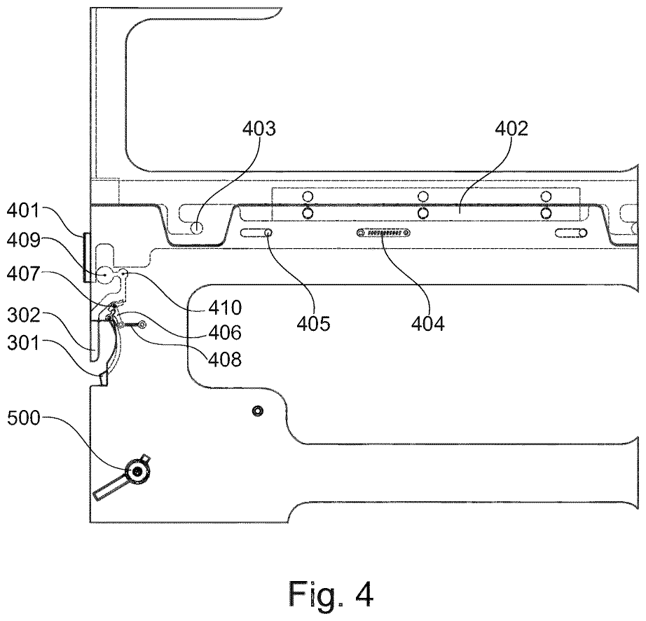

FIG. 4 shows the side view of the closed connection. The sliding lever 302 holds the movable latch 401 in its forward position until the fixing lever 301 is pressed as shown. The pivot point 410 of the sliding latch 302 is located slightly above the sliding bolt 409. The tension spring 404 therefore secures the lever in its position to such an extent that a force is first required to release it before the spring 404 supports the lifting of the sliding lever 302.

In addition, the closed position of the sliding lever (302) is fixed by the safety hook (406). It engages in a groove in the sliding lever (302) so that it cannot be lifted. Only when the color-coded fixing lever (301) is pressed does the safety hook (406) rotate around its pivot point (407) against the force of the weak tension spring of the safety hook (408) to such an extent that it releases the groove in the sliding lever (302) for separating the modules. The system is thus doubly secured against unintentional opening of the vertical module connection by the tension spring (404) and the safety hook (406).

### REFERENCE NUMERALS

100 module with mid-range and high-frequency converters and sub bass
101 module with mid-range and high-frequency converters
200 trusses for suspending the system
201 left connection element consisting of two steel plates and connecting mechanism in between
202 right connection element consisting of two steel plates and connecting mechanism in between
203 outer panels
301 fixing lever
302 sliding lever
401 movable latch
402 rail for force absorption
403 connection bolt
404 tension spring
405 guide bolt
406 safety hook
407 pivot point of the safety hook
408 tension spring of the safety hook
409 sliding bolts
410 pivot point of the safety hook
500 horizontal connection element

1. A support system with connection elements (201) for screwing on the left-hand side and (202) for screwing on the right-hand side of sound converter modules,
characterized in that the
connection elements each comprise two outer panels (203), between which an adjusting device, in particular for horizontal displaceability implements a releasable connection of the modules to the elements (301) to (500), wherein this support system is suitable for connecting a large number of loudspeaker modules to a flat baffle.

2. The support system with connection elements (201) for screwing on the left-hand side and (202) for screwing on the right-hand side of sound converter modules according to claim 1,
characterized in that
it is also possible to install the modules of type (100) reversely, i.e. with their radiating side to the rear, which can be advantageous when setting up large systems in order to achieve a cardioid directivity of the entire system even in the bass range.

3. The support system with connection elements (201) for screwing on the left-hand side and (202) for screwing on the right-hand side of sound converter modules according to claim 1 or 2,
characterized in that
it can accommodate modules of different depths if appropriate fastening holes are provided in the support system.

4. The support system with connection elements (201) for screwing on the left-hand side and (202) for screwing on the right-hand side of sound converter modules according to at least one of the preceding claims,
characterized in that
the vertical connection to a module column is made via a movable latch (401) which is embedded between the two outer panels (203) and which can be moved along two guide bolts (405), wherein in the closed state it hooks into the bolts (403) connected to the module located above.

5. The support system with connection elements (201) for screwing on the left-hand side and (202) for screwing on the right-hand side of sound converter modules according to at least one of the preceding claims,
characterized in that
an optional horizontal connection of the module columns by means of the levers (500) or other connection options can improve the dimensional stability of the system.

6. The support system with connection elements (201) for screwing on the left-hand side and (202) for screwing on the right-hand side of sound converter modules according to at least one of the preceding claims,
characterized in that
the pivot point of the safety hook (410) is located slightly above the center of the sliding bolt (409), whereby the tension spring secures the sliding lever (302) in its closed position to such an extent that a force is first required to release it before the tension spring (404) supports the lifting of the sliding lever (302).

7. The support system with connection elements (201) for screwing on the left-hand side and (202) for screwing on the right-hand side of sound converter modules according to at least one of the preceding claims,
characterized in that
the closed position of the sliding lever (302) is fixed by the safety hook (406), which engages in a groove in the sliding lever (302) in such a way that the latter cannot be lifted until pressure on the fixing lever (301) rotates the safety hook (406) against the force of a weak tension spring of the safety hook (408) to such an extent that it releases the groove in the sliding lever (302) for separating the modules.
